(19) United States
(12) Patent Application Publication
(10) Pub. No.: US 2006/0291357 A1
(43) Pub. Date: Dec. 28, 2006

(54) Information recording processing device, information reproduction processing device, information recording medium and method, and computer program

(75) Inventors: Tsutomu Ichinose, Tochigi (JP); Shunsuke Furukawa, Tokyo (JP); Takuya Wada, Tokyo (JP)

Correspondence Address: BELL, BOYD & LLOYD, LLC, P. O. BOX 1135, CHICAGO, IL, 60690-1135, US

(73) Assignee: SONY CORPORATION, Tokyo (JP)

(21) Appl. No.: 10/571,307

(22) PCT Filed: Sep. 1, 2004
(86) PCT No.: PCT/JP04/12655

§ 371 Date: Apr. 26, 2006

(30) Foreign Application Priority Data
Sep. 11, 2003 (JP) 2003-319589

(51) Int. Cl. G11B 19/04

(52) U.S. Cl. 369/53.21

(57) ABSTRACT

A device, a medium, and a method for recording and reproducing additional data difficult to analyze on an information recording medium are provided. When additional data is recorded onto the information recording medium, or additional data such for example as key information applied to a content decryption process, key generating information, content reproduction control information, or copy control information is recorded on the information recording medium, the parity of data of a recording frame in which to insert the additional data is calculated, and the value of a DC control bit in the frame in which to store the additional data is determined and set on the basis of information indicating whether the parity is even parity or odd parity and the bit value information [0] or [1] of the additional data. At a time of reproduction, the constituent bit [0] or [1] of the additional data is obtained by only detecting the parity of the recording frame.

### TECHNICAL FIELD

The present invention relates to an information recording processing device, an information reproduction processing device, an information recording medium and a method, and a computer program. More particularly, the present invention relates to an information recording processing device, an information reproduction processing device, an information recording medium and a method, and a computer program that make it possible to record and read additional information, or various additional information such for example as key information applied to a content decryption process, content reproduction control information, or copy control information on an information recording medium on which contents such for example as image data and music data are recorded in a mode difficult to analyze by controlling the setting of DC control bits.

### BACKGROUND ART

When data such as music data, image data and the like is recorded as digital data onto a recording medium, a recording process is performed according to a predetermined recording format. For example, an error detecting/correcting code is added to original data to be recorded, and the data is converted (coding) into a format corresponding to a specific data recording and reproduction process and then recorded.

A system has recently been developed which records and reproduces information using a blue laser as an information recording medium allowing high-density information recording. In an information recording process using this blue laser, a modulating process is performed which basically modulates two-bit data into three-bit data.

There are movies, music data and the like as contents stored on such an information recording medium. A distribution right or the like to many contents such as music data, image data and the like is generally held by a creator or a seller of the contents. Thus, generally, in distributing these contents, a certain use limitation is set, that is, only authorized users are permitted to use the contents so that unauthorized copying or the like is prevented.

Data of one to several movies, for example, can be recorded on a single high-capacity type recording medium such for example as a recording medium using a blue laser recording system allowing high-capacity recording. As contents can be thus recorded easily as digital information, a problem of a flood of unauthorized copies frequently occurs, and therefore a problem of impaired interests of holders of content copyrights and distribution rights is becoming more serious. Because of such a present situation, prevention of unauthorized copying and protection of interests of holders of content copyrights and distribution rights are an important challenge.

In order to prevent such unauthorized use of contents, a constitution is proposed in which contents stored on an information recording medium are recorded as encrypted contents, and encryption key information applied to use of the encrypted contents, information necessary to generate an encryption key, or various control information for content reproduction control, copy control and the like is stored as secret information on the information recording medium. A reproduction processing program executed in a reproducing device of a user reads secret information such as a key or the like corresponding to contents to be reproduced, decrypts the contents according to the read secret information, and allows the contents to be used according to reproduction control information.

As a conventional technique in which a secret information embedding process constitution is disclosed (see Japanese Patent Laid-open No. 2003-451487 as Patent Document 1), for example, discloses a constitution that embeds special data by using connection bits (margin bits) of EFM modulated data. Japanese Patent Laid-open No. 2002-367282 as Patent Document 2 discloses a constitution in which a plurality of conversion tables are applied in a modulating process, and at a time of reproduction, data on a conversion table applied in modulation is extracted and additional data is obtained on the basis of the extracted data.

However, when information indicating where such an encryption key or control information is stored on an information recording medium is obtained by a user or an unauthorized contents user, the additional information can be leaked or altered. For example, a problem of alteration of reproduction control information and copy control information or leakage of key information occurs. When key information is leaked or control information is altered, a form of use of contents which form is based on legitimate rights to use the contents collapses, and copyrights and distribution rights of the contents are not fully protected.

### DISCLOSURE OF INVENTION

The present invention has been made in view of the above problems, and it is an object of the present invention to provide an information recording processing device, an information reproduction processing device, an information recording medium and a method, and a computer program that make it possible to record various information such for example as an encryption key, encryption key generating information, content reproduction control information, content copy control information, or other content attribute information stored on a recording medium together with contents in a mode that makes it impossible to read the additional information by a general data reading process, and make unauthorized data reading difficult.

According to a first aspect of the present invention, there is provided an information recording processing device characterized by including: a modulated data generating unit for generating a modulated recording frame by setting a DC control bit in data to be recorded and performing data modulation processing; and a DC control bit specifying unit for determining a bit value of the DC control bit set in a recording frame in which to store additional data on a basis of a constituent bit value of the additional data and a data state of constituent data of the recording frame.

Further, in an embodiment of the information recording processing device according to the present invention, the data state of the constituent data of the recording frame in which to store the additional data is a state of whether parity of the constituent data of the recording frame is even parity or odd parity, and the DC control bit specifying unit determines the bit value of the DC control bit set in the recording frame on a basis of two conditions of whether the constituent bit value of the additional data is zero or one and whether the parity of the constituent data of the recording frame is even parity or odd parity.

Further, in an embodiment of the information recording processing device according to the present invention, the DC control bit specifying unit determines whether to set total parity of all DC control bits set in the recording frame in which to store the additional data to even parity or to odd parity on a basis of the constituent bit value of the additional data and the data state of the constituent data of the recording frame in which to store the additional data.

Further, in an embodiment of the information recording processing device according to the present invention, the information recording processing device sets the additional data as constituent information of at least one of encryption key information, encryption key generating information, content reproduction control information, and content copy control information for contents stored on the information recording medium.

Further, in an embodiment of the information recording processing device according to the present invention, the modulated data generating unit generates the modulated recording frame by performing a data conversion process satisfying RLL (1, 7) as a run length rule.

Further, in an embodiment of the information recording processing device according to the present invention, the modulated data generating unit performs a modulated recording frame generating process including a process of conversion of two-bit information into three-bit information.

Further, according to a second aspect of the present invention, there is provided an information reproduction processing device for reproducing information stored on an information recording medium, the information reproduction processing device characterized by including: a demodulating unit for demodulating data read from the information recording medium; and an additional data decoding unit for calculating a state of recorded data, and obtaining constituent bit information of additional data as recorded information stored in an additional data recording area on a basis of a result of calculating the state.

Further, in an embodiment of the information reproduction processing device according to the present invention, the state of the recorded data, the state being calculated by the additional data decoding unit, is parity of constituent data of a modulated recording frame corresponding to the additional data recording area, and whether a constituent bit value of the additional data is zero or one is determined on a basis of the state of whether the parity is even parity or odd parity.

Further, in an embodiment of the information reproduction processing device according to the present invention, the information reproduction processing device generates at least one of encryption key information, encryption key generating information, content reproduction control information, and content copy control information for contents stored on the information recording medium on a basis of the obtained constituent bit information of the additional data.

Further, according to a third aspect of the present invention, there is provided an information recording medium characterized in that a recording frame corresponding to an additional data recording area is a recording frame in which a DC control bit having a bit value determined on a basis of two conditions of a constituent bit value of additional data and whether parity of constituent data of the recording frame is even parity or odd parity is set, and data based on the recording frame is recorded on the information recording medium.

Further, in an embodiment of the information recording medium according to the present invention, the recording frame corresponding to the additional data recording area is recorded with total parity of DC control bits set to one of even parity and odd parity according to a predetermined rule on a basis of a correspondence between the constituent bit value of the additional data and a data state of the constituent data of the recording frame in which to store the additional data.

Further, in an embodiment of the information recording medium according to the present invention, the information recording medium stores the additional data as constituent information of at least one of encryption key information, encryption key generating information, content reproduction control information, and content copy control information for contents stored on the information recording medium.

Further, in an embodiment of the information recording medium according to the present invention, the data based on a modulated recording frame generated by performing a data conversion process satisfying RLL (1, 7) as a run length rule is recorded on the information recording medium.

Further, in an embodiment of the information recording medium according to the present invention, the data based on a modulated recording frame generated by performing a process of converting two-bit information into three-bit information is recorded on the information recording medium.

Further, according to a fourth aspect of the present invention, there is provided an information recording processing method characterized by including: a DC control bit specifying step of determining a bit value of a DC control bit set in a recording frame in which to store additional data on a basis of a constituent bit value of the additional data and a data state of constituent data of the recording frame; and a modulated data generating step of generating a modulated recording frame by setting the DC control bit specified in the DC control bit specifying step in data to be recorded and performing data modulation processing.

Further, in an embodiment of the information recording processing method according to the present invention, the data state of the constituent data of the recording frame in which to store the additional data is a state of whether parity of the constituent data of the recording frame is even parity or odd parity, and the DC control bit specifying step includes a step of determining the bit value of the DC control bit set in the recording frame on a basis of two conditions of whether the constituent bit value of the additional data is zero or one and whether the parity of the constituent data of the recording frame is even parity or odd parity.

Further, in an embodiment of the information recording processing method according to the present invention, the DC control bit specifying step includes a step of determining whether to set total parity of all DC control bits set in the recording frame in which to store the additional data to even parity or to odd parity on a basis of the constituent bit value of the additional data and the data state of the constituent data of the recording frame in which to store the additional data.

Further, in an embodiment of the information recording processing method according to the present invention, the additional data is constituent information of at least one of encryption key information, encryption key generating information, content reproduction control information, and content copy control information for contents stored on the information recording medium.

Further, in an embodiment of the information recording processing method according to the present invention, the modulated data generating step generates the modulated recording frame by performing a data conversion process satisfying RLL (1, 7) as a run length rule.

Further, in an embodiment of the information recording processing method according to the present invention, the modulated data generating step performs a modulated recording frame generating process including a process of conversion of two-bit information into three-bit information.

Further, according to a fifth aspect of the present invention, there is provided an information reproduction processing method for reproducing information stored on an information recording medium, the information reproduction processing method characterized by including: a demodulating step of demodulating data read from the information recording medium; and an additional data decoding step of calculating a state of recorded data, and obtaining constituent bit information of additional data as recorded information stored in an additional data recording area on a basis of a result of calculating the state.

Further, in an embodiment of the information reproduction processing method according to the present invention, the additional data decoding step includes a step of calculating parity of constituent data of a modulated recording frame corresponding to the additional data recording area as the state of the recorded data, and determining whether a constituent bit value of the additional data is zero or one on a basis of the state of whether the parity is even parity or odd parity.

Further, in an embodiment of the information reproduction processing method according to the present invention, the information reproduction processing method further includes a step of generating at least one of encryption key information, encryption key generating information, content reproduction control information, and content copy control information for contents stored on the information recording medium on a basis of the obtained constituent bit information of the additional data.

Further, according to a sixth aspect of the present invention, there is provided a computer program for performing an information recording process, the computer program characterized by including: a DC control bit specifying step of determining a bit value of a DC control bit set in a recording frame in which to store additional data on a basis of a constituent bit value of the additional data and a data state of constituent data of the recording frame; and a modulated data generating step of generating a modulated recording frame by setting the DC control bit specified in the DC control bit specifying step in data to be recorded and performing data modulation processing.

Further, according to a seventh aspect of the present invention, there is provided a computer program for reproducing information stored on an information recording medium, the computer program characterized by including: a demodulating step of demodulating data read from the information recording medium; and an additional data decoding step of calculating a state of recorded data, and obtaining constituent bit information of additional data as recorded information stored in an additional data recording area on a basis of a result of calculating the state.

The computer programs according to the present invention can for example be provided to a computer system capable of executing various program codes by a storage medium provided in a computer readable form, or a communicating medium, for example a recording medium such as a CD, an FD, an MO or the like, or a communicating medium such as a network or the like. By providing such a program in a computer readable form, a process in accordance with the program is realized on the computer system.

Other and further objects, features, and advantages of the present invention will become apparent from more detailed description on the basis of accompanying drawings and embodiments of the present invention to be described later. It is to be noted that a system in the present specification is a logical set configuration of a plurality of devices, and that each constituent device is not necessarily within an identical casing.

According to a constitution of the present invention, in a recording processing device that records additional data onto an information recording medium, or records various additional data such for example as key information applied to a content decrypting process, key generating information, content reproduction control information, or copy control information onto the information recording medium, the value of a DC control bit embedded in a recording frame is determined and set according to a state of a data area corresponding to an additional data embedding area and a bit value [0] or [1] as constituent bit information of additional data. At a time of reproduction, a reproducing device can obtain the additional constituent bit information [0] or [1] by detecting the data state of constituent data of the recording frame. With this constitution, additional information such for example as key information applied to a content decrypting process, key generating information, content reproduction control information, or copy control information is embedded in a mode difficult to analyze, and reliably read at a time of reproduction.

In addition, according to a constitution of the present invention, in a process of recording additional data, on the basis of a data state of whether parity of data of a recording frame in which to insert the additional data is even parity or odd parity and bit value information [0] or [1] of the additional data, the constituent bit [0] or [1] of the additional data can be recorded by only determining and setting the value of a DC control bit of the frame in which to store the additional data. At a time of reproduction, the additional information can be obtained by only detecting the parity.

### BRIEF DESCRIPTION OF DRAWINGS

FIG. 1 is a diagram showing a configuration of an information recording processing device according to the present invention;

FIGS. 2A, 2B, 2C, and 2D are diagrams (1) of assistance in explaining details of processing of a modulated data generating unit in the information recording processing device according to the present invention;

FIGS. 3D, 3E, 3F, 3G, and 3H are diagrams (2) of assistance in explaining details of processing of the modulated data generating unit in the information recording processing device according to the present invention;

FIG. 4 is a diagram of assistance in explaining a data composition of a conversion table applied in a modulation process of the information recording processing device according to the present invention;

FIGS. 5A, 5B, and 5C are diagrams of assistance in explaining details of processing performed in a recording signal processing circuit in the information recording processing device according to the present invention;

FIGS. 6A, 6B, and 6C are diagrams of assistance in explaining an example of a process of setting DC control bits on the basis of additional data which process is performed in the information recording processing device according to the present invention;

FIGS. 7A, 7B, and 7C are diagrams of assistance in explaining an example of a process of setting DC control bits on the basis of additional data which process is performed in the present invention;

FIG. 8 is a diagram of assistance in explaining a rule for the process of setting DC control bits on the basis of additional data which process is performed in the present invention;

FIG. 9 is a flowchart of assistance in explaining an additional data recording process sequence performed in the information recording processing device according to the present invention;

FIG. 10 is a diagram showing a configuration of an information reproduction processing device according to the present invention; and

FIG. 11 is a flowchart of assistance in explaining an additional data reading and data reproduction process sequence performed in the information reproduction processing device according to the present invention.

### BEST MODE FOR CARRYING OUT THE INVENTION

An information recording processing device, an information reproduction processing device, an information recording medium, and a method, and a computer program according to the present invention will hereinafter be described in detail with reference to the drawings.

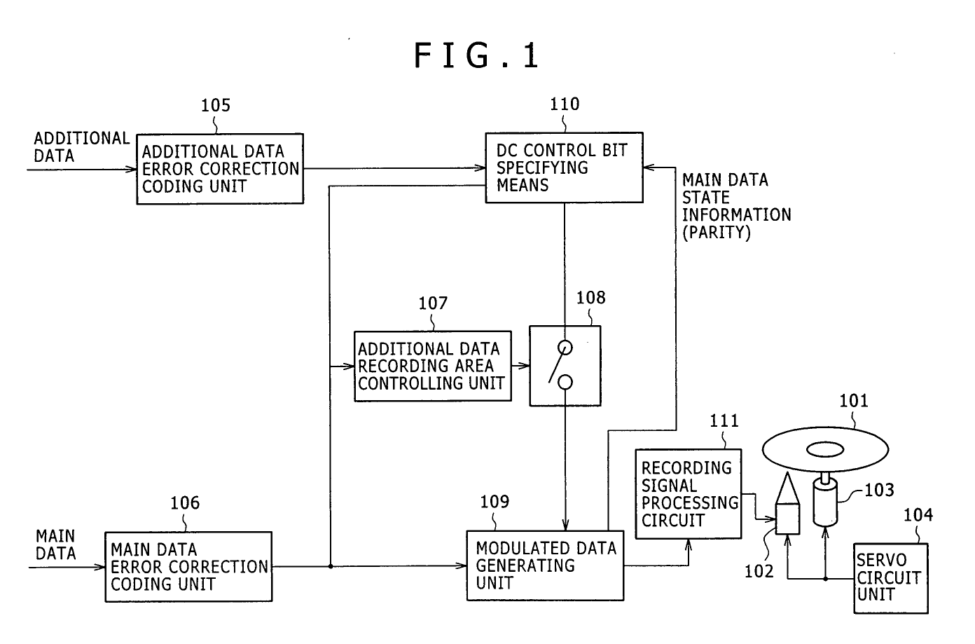

The configuration and processing of the information recording processing device according to the present invention will first be described with reference to FIG. 1. It is to be noted that the information recording processing device to be described in the following includes a mastering device as a device for manufacturing an original disk referred to as a so-called master disk, and further includes a DVD recording and reproducing device and a device having an information recording medium drive, such as a PC or the like, which devices are usable by a general user. That is, the information recording processing device includes information processing devices that can write data not only to master disks but also to various recordable or rewritable information recording media.

The configuration and processing of the information recording processing device will be described with reference to FIG. 1. The information recording processing device includes: an information recording medium 101 on which data can be recorded; a pickup 102 for outputting a data recording signal to the information recording medium 101; a spindle motor 103 for driving the information recording medium 101; a servo circuit 104 for controlling the pickup 102 and the spindle motor 103; an additional data error correction coding unit 105; a main data error correction coding unit 106; an additional data recording area controlling unit 107; a switch 108; a modulated data generating unit 109; DC control bit specifying means 110; and a recording signal processing circuit 111.

Content data to be recorded on the information recording medium 101 is encrypted content data, for example. The content data is input as main data to the main data error correction coding unit 106. The main data error correction coding unit 106 performs a coding process of generating an error correcting code and adding the error correcting code to the input data.

Thereafter the modulated data generating unit 109 performs a modulating process. The information recording processing device according to the present invention performs modulation based on an RLL (1, 7) modulation system for basically modulating two-bit data into three-bit data.

The modulation based on the RLL (1, 7) modulation system is a data conversion system for providing modulated data in accordance with an RLL (1, 7) run length limitation in which data the number of consecutive [0] bits after the modulation is in a range of a minimum of one to a maximum of seven. Incidentally, a conversion table is used in this conversion process. A concrete example of use of a conversion table will be described later.

A recording unit referred to as a recording frame in which a synchronizing signal is set is generated on the basis of the modulated data, and recorded onto the information recording medium 101 via the recording signal processing circuit 111.

The modulating process is performed after a DC control bit [0] or [1] is selected and inserted at certain intervals of the input main data so as to reduce an absolute value of DSV (Digital Sum Variation) at the time of modulation.

However, in the present invention, in setting a DC control bit in an additional data recording area, a DC control bit [0] or [1] is selected and inserted on the basis of a constituent bit of additional data, instead of bit selection according to the above rule. This process will be described later.

The digital sum variation (DSV) is an index of a DC balance of an NRZI converted signal generated as a recording signal to be recorded on the information recording medium. Specifically, with the DSV as a value obtained by accumulating bits [0] in a recording bit sequence (NRZI converted signal) as [−1] and bits [1] in the recording bit sequence (NRZI converted signal) as [+1], the modulating process is performed after a DC control bit [0] or [1] is selected and inserted so as to reduce a deviation of the DSV from zero. Incidentally, an NRZI conversion process will be described later in detail.

Incidentally, in the configuration according to the present invention, in setting a DC control bit in an additional data recording area, a DC control bit [0] or [1] is selected and inserted on the basis of a constituent bit of additional data, instead of bit selection according to the above rule. This process will be described later.

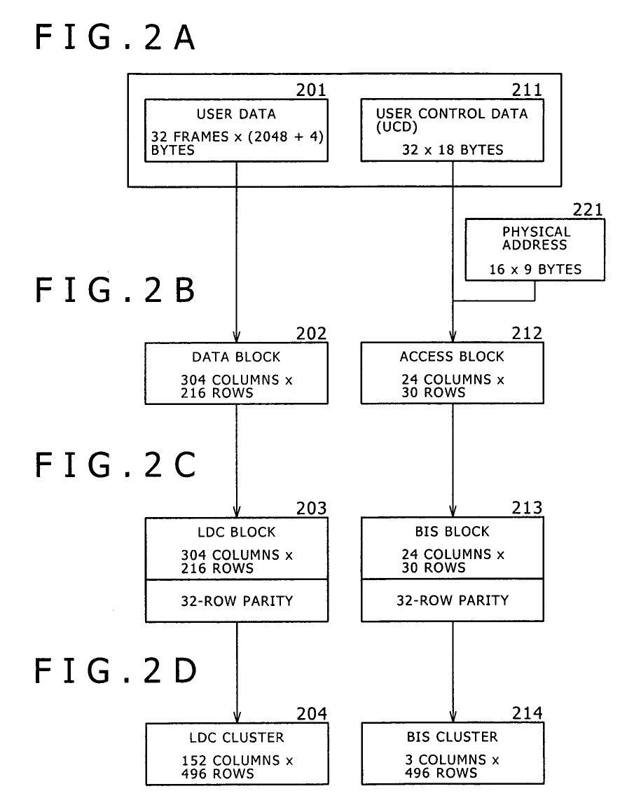

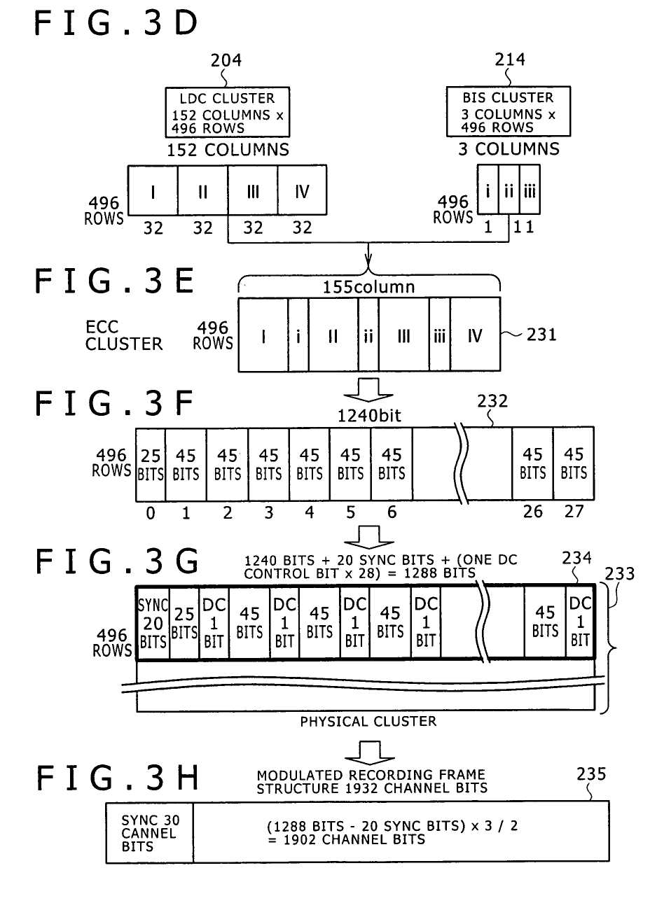

A modulated data generating process performed in the modulated data generating unit 109 will be described in detail with reference to FIG. 2 and FIG. 3.

As shown in FIG. 2A, recording data is formed by user data 201 and user control data (UCD) 211. The user data 201 includes entity data of data to be reproduced such as contents or the like. The user control data (UCD) 211 includes various control data such as reproduction control information and the like.

The user data 201 is set as a unit of 32 frames of 2048-byte data and four-byte parity. The user control data (UCD) 211 is formed by 32 units of 18-byte data.

A data block 202 is formed on the basis of the user data 201 of 32 frames×(2048+4) bytes. The data block 202 has an arrangement of 304 columns×216 rows. Incidentally, one column×one row stores one-byte (eight-bit) data.

An LDC block 203 is generated as a data block obtained by adding 32-row parity to each column of the data block 202. An LDC cluster 204 of 152 columns×496 rows is generated by subjecting the LDC block 203 to an interleaving process.

The user control data (UCD) 211 is combined with physical address data 221 of 16×9 bytes, whereby an access block 212 of 24 columns×30 rows is generated. A BIS block 213 is generated as a data block obtained by adding 32-row parity to each column of the access block 212. A BIS cluster 214 of three columns×496 rows is generated by subjecting the BIS block 213 to an interleaving process.

FIG. 3D shows the same data as in FIG. 2D, that is, the LDC cluster 204 of 152 columns×496 rows generated on the basis of the user data 201 and the BIS cluster 214 of three columns×496 rows generated on the basis of the user control data (UCD) 211.

As shown in FIG. 3D, the LDC cluster 204 of 152 columns×496 rows is divided into four parts (I to IV) as units of 32 columns, and the BIS cluster 214 of three columns×496 rows is divided into three parts (i to iii) as units of one column. These parts are alternately combined with each other, whereby an ECC cluster 231 of 155 columns×496 rows shown in FIG. 3E is generated.

Further, the ECC cluster 231 is set as a cluster 232 divided into 28 parts 0 to 27 as shown in FIG. 3F. Only the part 0 is 25 bits, and the other parts 1 to 27 are 45 bits. Incidentally, the number of bits shown in FIG. 3F is the number of bits per row.

Further, as shown in FIG. 3G, 20 synchronizing (Sync) bits are set. In addition, one DC control bit is set between the parts 0 to 27 of FIG. 3F.

As a result, a physical cluster 233 of [1240+20 (Sync)+(one DC control×28)=1288]×496 rows is set. Each row of the physical cluster 233 is a recording frame 234 as a modulated data generating process unit.

Incidentally, the DC control bits are an index of a DC balance of an NRZI converted signal generated as a recording signal to be recorded on the information recording medium. Specifically, with DSV as a value obtained by accumulating bits [0] in a recording bit sequence (NRZI converted signal) as [−1] and bits [1] in the recording bit sequence (NRZI converted signal) as [+1], a DC control bit [0] or [1] is selected and inserted so as to reduce a deviation of the DSV from zero.

However, as described above, in the present invention, in setting a DC control bit in an additional data recording area, a DC control bit [0] or [1] is selected and inserted on the basis of a constituent bit of additional data, instead of bit selection according to the above rule. This process will be described later.

Returning to FIG. 3, description of the modulated data generating process will be continued. The recording frame 234 formed by 1288-bit data is subjected to a modulation process for converting two-bit data into three-bit data. In this data conversion, RLL (1, 7) data conversion is performed to provide modulated data in accordance with a run length limitation in which data the number of consecutive [0] bits is in a range of a minimum of one to a maximum of seven, whereby a modulated recording frame 235 is generated.

The modulated recording frame 235 is formed by a total of 1932 channel bits as modulated data bits, that is, 30 synchronizing (Sync) channel bits and (1288−20 sync bits×⅔)=1902 channel bits.

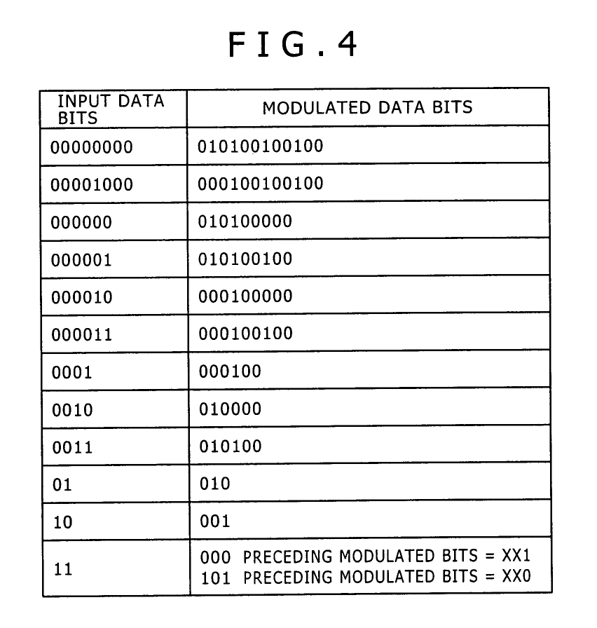

A conversion table is used in the process of data modulation from two bits to three bits in accordance with an RLL (1, 7) run length rule. A concrete example of a conversion table is shown in FIG. 4.

As shown in FIG. 4, the conversion table is constructed as a table associating modulated data bits with input bits. When input data is [00000000], for example, modulated data bits are [010100100100]. In a case of input data of [11], modulated data bits are [000] when preceding modulated data bits are [xx1], and modulated data bits are [101] when preceding modulated data bits are [xx0].

Modulated data bits in accordance with the RLL (1, 7) run length rule are generated by performing data conversion from two bits to three bits according to this table.

Returning to FIG. 1, description of the configuration and processing of the information recording processing device according to the present invention will be continued. The modulated data generating process described with reference to FIGS. 2A to 4 is performed in the modulated data generating unit 109 in FIG. 1, and a recording signal based on the generated modulated data is generated in the recording signal processing circuit 111.

The recording signal processing circuit 111 generates an NRZI (Non Return to Zero Inverted) signal whose pulse polarity is inverted according to a value [0] or [1] of the modulated data generated by the modulated data generating unit 109. This signal is recorded as a recording signal onto the information recording medium 101.

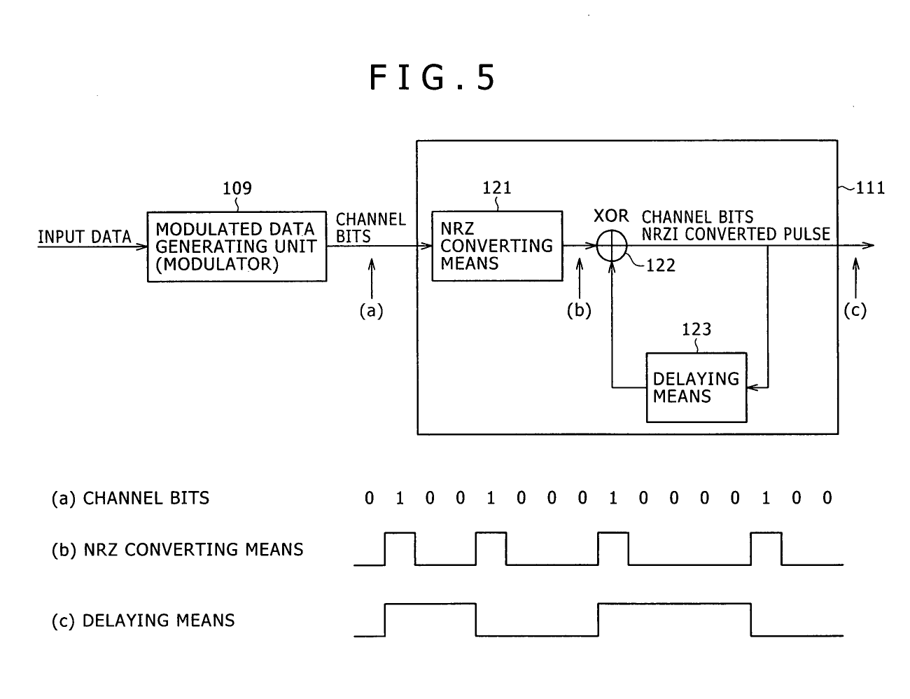

FIG. 5 shows a configuration for a process of generating an NRZI as a recording signal which process is performed in the recording signal processing circuit 111. Channel bits as modulated data bits output from the modulated data generating unit 109 is input to the recording signal processing circuit 111 including NRZ converting means 121, exclusive OR means (XOR) 122, and delaying means 123. FIG. 5A shows channel bits; FIG. 5B shows an output signal from the NRZ converting means 121; and FIG. 5C shows NRZI converted pulses, which are a recording signal as a final output of the recording signal processing circuit 111. This recording signal is output to the pickup 102, so that the recording information is recorded onto the information recording medium 101 under control of the servo circuit 104.

In the case of a recording frame corresponding to an additional data recording area, the constitution of the present invention determines whether to set a DC control bit (see FIG. 3G) to [0] or whether to set the DC control bit to [1], which setting is made in the modulated data generating unit 109, on the basis of a constituent bit of additional data.

For example, a specific recording frame is selected as an additional data recording area, and a DC control bit in the selected recording frame is selected to be [0] or [1] on the basis of a constituent bit of additional data. This process enables the additional data to be assigned to the modulated data.

In the constitution of FIG. 1, additional data is input to the additional data error correction coding unit 105 to be subjected to a coding process of adding an error correction code to the additional data. Incidentally, additional data is data formed by various information such as encryption key information, encryption key generating information, content reproduction control information, content copy control information, and other content attribute information.

The DC control bit specifying means 110 is supplied with a bit string of the additional data to which the error correcting code is added. The bit string is a data string of [0, 0, 0, 1, 0, 0, 0, 0 . . . ], for example. This bit string includes for example the additional data of either encryption key information, encryption key generating information, content reproduction control information, content copy control information, or other content attribute information, and the error correcting code added to the additional data.

The additional data recording area controlling unit 107 determines whether a recording frame is an area for setting an additional information bit on the basis of output data from the main data error correction coding unit 106. When the recording frame is an area for setting an additional information bit, the additional data recording area controlling unit 107 turns on the switch 108 to output DC control bit information determined by the DC control bit specifying means 110 on the basis of additional information to the modulated data generating unit 109. The modulated data generating unit 109 determines and sets the value of a DC control bit to be added to the recording frame corresponding to an additional data recording area according to the instruction from the DC control bit specifying means 110.

The DC control bit specifying means 110 is supplied with the data state value, for example parity of main data corresponding to the area for setting the additional information bit from the modulated data generating unit 109. The DC control bit specifying means 110 determines the value of the DC control bit on the basis of the value of the parity of the main data and the value of a constituent bit of additional data to be set.

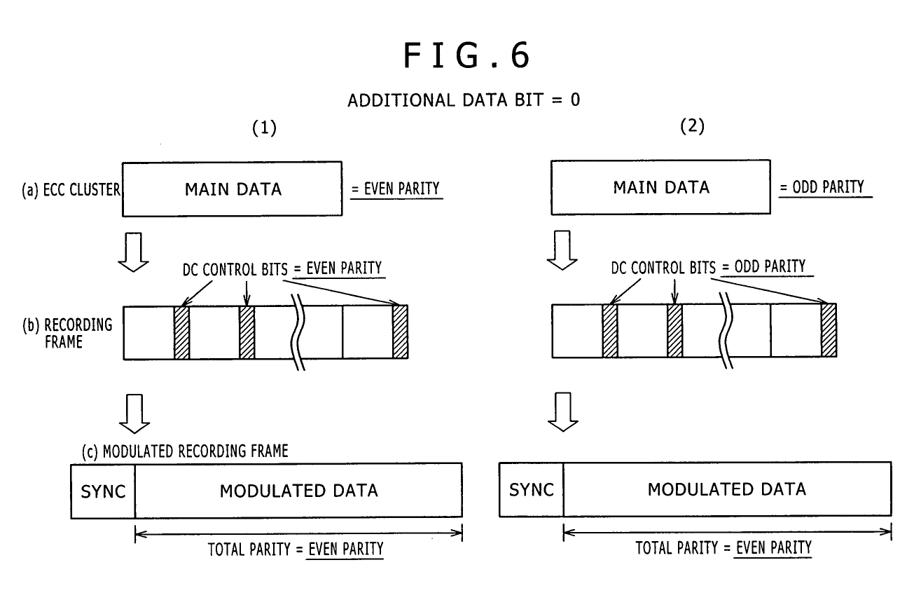

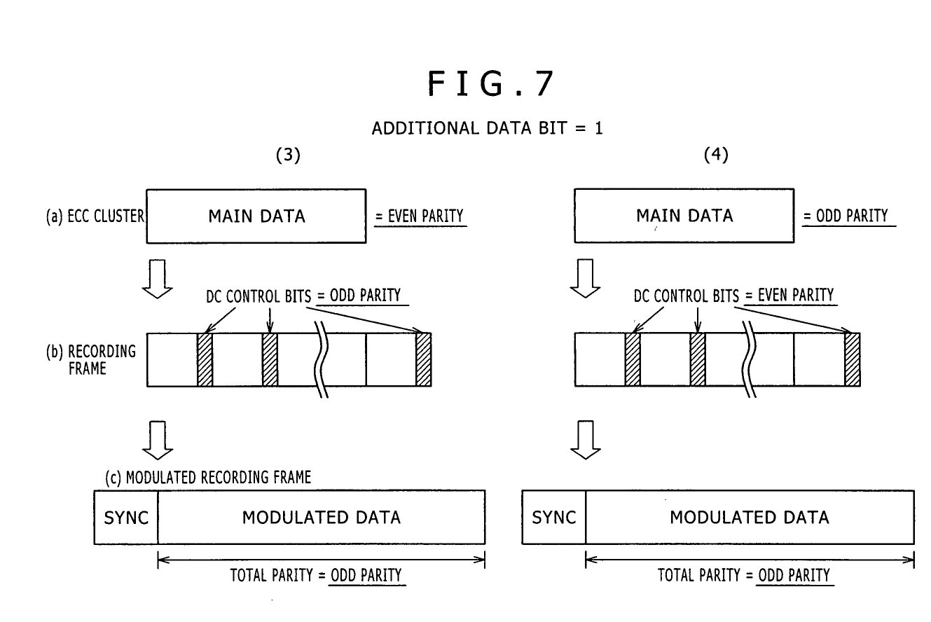

Details of processing performed by the DC control bit specifying means 110 will be described with reference to FIGS. 6A, 6B, and 6C and FIGS. 7A, 7B, and 7C.

FIGS. 6A, 6B, and 6C represent an example of setting when a constituent bit of additional data is [0]. FIG. 6(1) represents an example when a constituent bit of additional data is [0] and the parity of main data stored in an additional data setting area (recording frame) is even parity. FIG. 6(2) represents an example when a constituent bit of additional data is [0] and the parity of main data stored in an additional data setting area (recording frame) is odd parity.

Incidentally, even parity in a data area corresponds to a cumulative value of the number of bits 1 included in data included in the data area being an even number. Odd parity in a data area corresponds to a cumulative value of the number of 1s included in data included in the data area being an odd number.

It is to be noted that while an example shown in the following uses parity information as state value of a data area including an additional data inserting position, various other detectable state values are applicable as state value of a data area.

In the case of FIG. 6(1), that is, when a constituent bit of additional data is [0] and the parity of main data stored in an additional data setting area (recording frame) is even parity as shown in (a) of FIG. 6, the total parity of DC control bits inserted in the recording frame shown in (b) of FIG. 6 is adjusted to be even parity. A process for this adjustment is performed by the DC control bit specifying means 110.

Consequently, the total parity of a data part of a modulated recording frame shown in (c) of FIG. 6 which frame is generated by RLL (1, 7) modulation on the basis of the recording frame is set to even parity.

Incidentally, RLL (1, 7) modulation has a parity preserving characteristic, that is, has a characteristic in that modulated data of even parity data has even parity, and modulated data of odd parity data has odd parity.

Hence, in a case of additional data “00001111”, for example, when a first bit on a MSB side is to be embedded in modulated data, and modulated data bit pattern parity (the number of 1s) in a specific recording frame unit is odd parity, the parity of the specific recording frame unit can be set to even parity by changing one of DC control bits from [0] to [1] or from [1] to [0], and performing a modulating process. Thus the [0] of the additional data can be assigned.

Conversely, when the parity of the specific recording frame unit is odd parity, [1] of the additional data can be assigned. Thus, by assigning data to the parity of a modulated data bit pattern in an arbitrary specific recording frame unit, it is possible to record additional data that does not appear in normal demodulated data.

A reproducing device detects the total parity of the data part of the modulated recording frame, and determines that a constituent bit of additional data stored in the recording frame is [0] on the basis of a determination that the total parity of the data part of the modulated recording frame is even parity. Incidentally, details of an additional bit determining process in a reproducing process will be described later.

FIG. 6(2) represents an example when a constituent bit of additional data is [0] and the parity of main data stored in an additional data setting area (recording frame) is odd parity. The total parity of DC control bits inserted in the recording frame shown in (b) of FIG. 6 is adjusted to be odd parity. A process for this adjustment is performed by the DC control bit specifying means 110.

Consequently, the total parity of a data part of a modulated recording frame shown in (c) of FIG. 6 which frame is generated by RLL (1, 7) modulation on the basis of the recording frame is set to even parity.

A reproducing device detects the total parity of the data part of the modulated recording frame, and determines that a constituent bit of additional data stored in the recording frame is [0] on the basis of a determination that the total parity of the data part of the modulated recording frame is even parity.

(a), (b), and (c) of FIG. 7 represent an example of setting when a constituent bit of additional data is [1]. FIG. 7(3) represents an example when a constituent bit of additional data is [1] and the parity of main data stored in an additional data setting area (recording frame) is even parity. FIG. 7(4) represents an example when a constituent bit of additional data is [1] and the parity of main data stored in an additional data setting area (recording frame) is odd parity.

In the case of FIG. 7(3), that is, when a constituent bit of additional data is [1] and the parity of main data stored in an additional data setting area (recording frame) is even parity, the total parity of DC control bits inserted in the recording frame shown in (b) of FIG. 6 is adjusted to be odd parity. A process for this adjustment is performed by the DC control bit specifying means 110.

Consequently, the total parity of a data part of a modulated recording frame shown in (c) of FIG. 6 which frame is generated by RLL (1, 7) modulation on the basis of the recording frame is set to odd parity.

A reproducing device detects the total parity of the data part of the modulated recording frame, and determines that a constituent bit of additional data stored in the recording frame is [1] on the basis of a determination that the total parity of the data part of the modulated recording frame is odd parity.

FIG. 7(4) represents an example when a constituent bit of additional data is [1] and the parity of main data stored in an additional data setting area (recording frame) is odd parity. The total parity of DC control bits inserted in the recording frame shown in (b) of FIG. 6 is adjusted to be even parity. A process for this adjustment is performed by the DC control bit specifying means 110.

Consequently, the total parity of a data part of a modulated recording frame shown in (c) of FIG. 6 which frame is generated by RLL (1, 7) modulation on the basis of the recording frame is set to odd parity.

A reproducing device detects the total parity of the data part of the modulated recording frame, and determines that a constituent bit of additional data stored in the recording frame is [1] on the basis of a determination that the total parity of the data part of the modulated recording frame is odd parity.

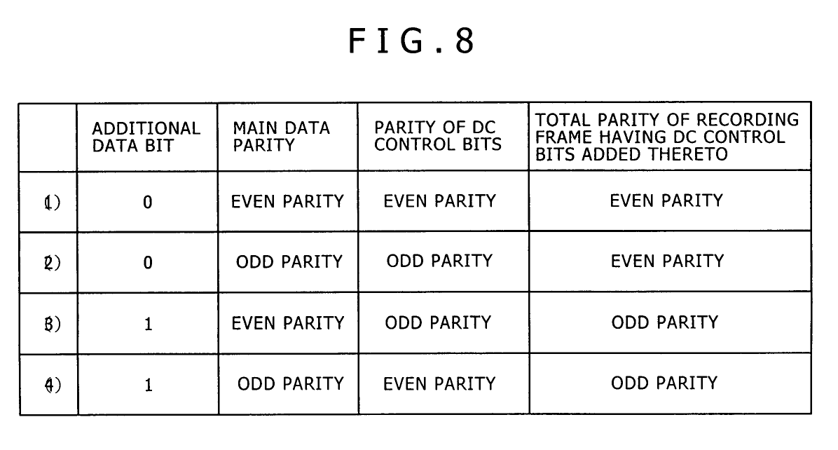

FIG. 8 is a table summarizing a rule for embedding DC control bits corresponding to additional data in the present invention.

FIG. 8 shows four patterns (1) to (4) described with reference to (a), (b), and (c) of FIG. 6 and (a), (b), and (c) of FIG. 7.

The pattern (1) represents a case where a constituent bit of additional data is [0] and the parity of main data stored in an additional data setting area (recording frame) is even parity. In this case, the total parity of DC control bits is set to be even parity. As a result of this setting, total parity corresponding to all data of a modulated recording frame in which the DC control bits are set is even parity. Thus, the even parity is detected by parity detection performed in a reproducing device at a time of reproduction, whereby data as an additional data constituent bit=0 can be obtained.

FIG. 8(2) represents a case where a constituent bit of additional data is [0] and the parity of main data stored in an additional data setting area (recording frame) is odd parity. In this case, the total parity of DC control bits is set to be odd parity. As a result of this setting, total parity corresponding to all data of a modulated recording frame in which the DC control bits are set is even parity. Thus, the even parity is detected by parity detection performed in a reproducing device at a time of reproduction, whereby data as an additional data constituent bit=0 can be obtained.

FIG. 8(3) represents a case where a constituent bit of additional data is [1] and the parity of main data stored in an additional data setting area (recording frame) is even parity. In this case, the total parity of DC control bits is set to be odd parity. As a result of this setting, total parity corresponding to all data of a modulated recording frame in which the DC control bits are set is odd parity. Thus, the odd parity is detected by parity detection performed in a reproducing device at a time of reproduction, whereby data as an additional data constituent bit=1 can be obtained.

FIG. 8(4) represents a case where a constituent bit of additional data is [1] and the parity of main data stored in an additional data setting area (recording frame) is odd parity. In this case, the total parity of DC control bits is set to be even parity. As a result of this setting, total parity corresponding to all data of a modulated recording frame in which the DC control bits are set is odd parity. Thus, the odd parity is detected by parity detection performed in a reproducing device at a time of reproduction, whereby data as an additional data constituent bit=1 can be obtained.

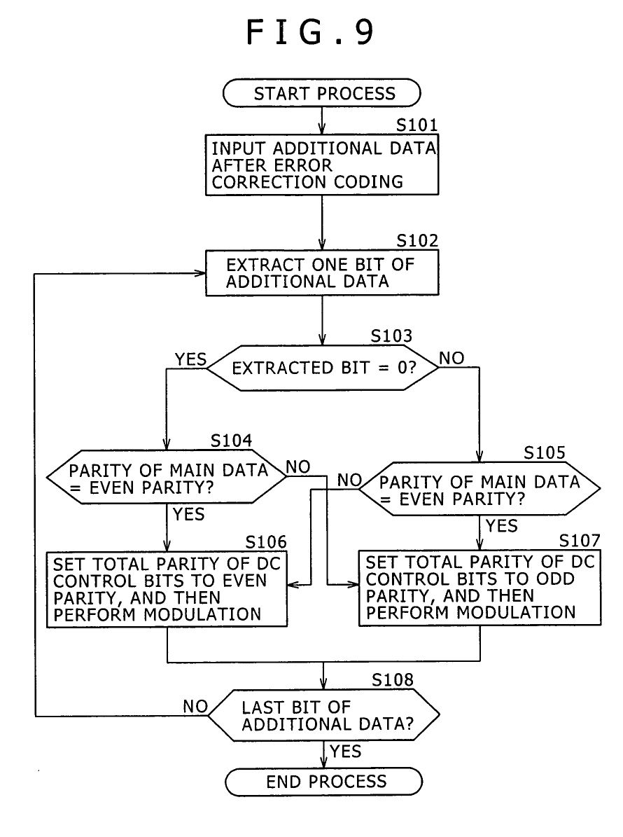

The sequence of an additional data recording process performed by the DC control bit specifying means 110 in the information recording processing device according to the present invention will next be described with reference to FIG. 9.

In step S101, additional data after error correction coding is input. This data is output from the additional data error correction coding unit 105 shown in FIG. 1. The data is formed by various information such as encryption key information, encryption key generating information, content reproduction control information, content copy control information, and other content attribute information. A bit string of the additional data to which an error correcting code is added, for example a data string [0, 0, 0, 1, 0, 0, 0 . . . ] or the like is input to the DC control bit specifying means 110.

In step S102, one bit is extracted as a recording bit in order from the constituent bits, for example, [0, 0, 0, 1, 0, 0, 0 . . . ] of the additional data. In step S103, whether the recording bit is [0] is determined.

When the recording bit is [0], the process proceeds to step S104. When the recording bit is [1], the process proceeds to step S105.

When the recording bit is [0], the parity of main data in a data area in which to store additional data is determined in step S104. When the parity of the main data is even parity, the process proceeds to step S106, where the total parity of DC control bits is set to even parity, and then a modulating process is performed. As a result, the total parity of modulated data is set to even parity. This process corresponds to a process for (b) and (c) in FIG. 6(1).

When it is determined in step S104 that the parity of the main data in the data area in which to store the additional data is odd parity, the process proceeds to step S107, where the total parity of the DC control bits is set to odd parity, and then a modulating process is performed. As a result, the total parity of modulated data is set to even parity. This process corresponds to a process for (b) and (c) in FIG. 6(2).

When the recording bit is [1], the parity of the main data in the data area in which to store the additional data is determined in step S105. When the parity of the main data is even parity, the process proceeds to step S107, where the total parity of the DC control bits is set to odd parity, and then a modulating process is performed. As a result, the total parity of modulated data is set to odd parity. This process corresponds to a process for (b) and (c) in FIG. 7(3).

When it is determined in step S105 that the parity of the main data in the data area in which to store the additional data is odd parity, the process proceeds to step S106, where the total parity of the DC control bits is set to even parity, and then a modulating process is performed. As a result, the total parity of modulated data is set to odd parity. This process corresponds to a process for (b) and (c) in FIG. 7(4).

In step S108, it is determined whether processing of a last bit of the additional data is completed. When there is unprocessed data, the process from step S102 on down is repeated.

When it is determined in step S108 that there is no unprocessed data, the process is ended, that is, recording data having additional information bits inserted therein is generated according to the above-described process.

Description will next be made of a configuration and a reproducing process sequence of a data reproduction processing device that reproduces an information recording medium storing the above-described additional information and contents (main data) such as a movie, music or the like.

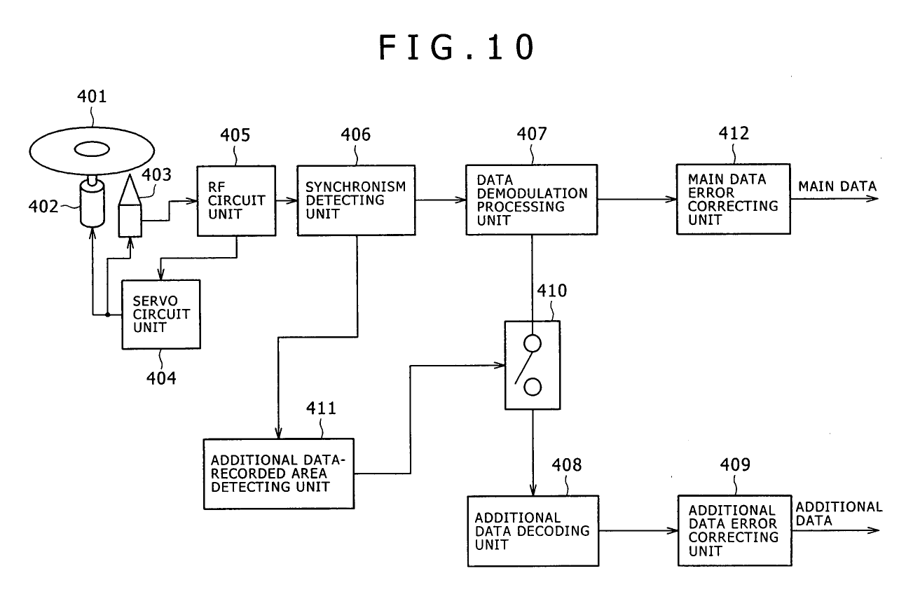

The configuration and processing of the data reproduction processing device will be described with reference to FIG. 10. The data reproduction processing device includes: an information recording medium 401; a pickup 402 for reading data from the information recording medium 401; a spindle motor 403 for driving the information recording medium 401; a servo circuit 404 for controlling the pickup 402 and the spindle motor 403; an RF circuit unit 405 for performing signal processing such as gain adjustment of a read signal and the like, and generating an RF signal; a synchronism detecting unit 406 for extracting a synchronizing signal from the RF signal; a data demodulation processing unit 407 for performing data demodulation processing; a switch 410 for outputting a signal read only from an area of additional data on the information recording medium to an additional data decoding unit 408; an additional data-recorded area detecting unit 411 for detecting the area of the additional data and controlling the switch 410; the additional data decoding unit 408 for decoding the additional data; a main data error correcting unit 412 for performing error correction processing on main data; and an additional data error correcting unit 409 for performing error correction processing on the additional data.

Content data stored on the information recording medium 401 is encrypted content data, for example. The additional data stored on the information recording medium 401 is for example key data applied to the decryption of encrypted contents, key generating information, content reproduction control information, content copy control information, and other content attribute information.

Data read from the information recording medium 401 via the pickup 402 is subjected to signal processing such as gain adjustment and the like in the RF circuit unit 405, and then input to the synchronism detecting unit 406. The synchronism detecting unit 406 detects a synchronizing signal (sync) in the recorded signal. The synchronism detecting unit 406 outputs the detected signal to the additional data-recorded area controlling unit 411. The additional data-recorded area controlling unit 411 determines an additional data recording area on the basis of the synchronizing signal input from the synchronism detecting unit 406. The additional data-recorded area detecting unit 411 controls the switch 410 on the basis of information on the determination to input modulated data of the area necessary to decode additional data to the additional data decoding unit 408, which decodes the additional data.

On the basis of the input modulated data, the additional data decoding unit 408 performs a decoding process to obtain the additional data. Specifically, the additional data decoding unit 408 detects a data state value (parity) in a predetermined modulated data area including an additional data storing area, and determines whether the constituent bit of the additional data is [0] or [1] on the basis of the detected state value.

That is, the additional data decoding unit 408 calculates the total parity of a data part of a recording frame in which the additional data is set. When the total parity is even parity, the additional data decoding unit 408 determines that the constituent bit of the additional data=[0]. When the total parity is even parity, the additional data decoding unit 408 determines that the constituent bit of the additional data=[1].

Thus, in the reproducing device, in the case of a frame having additional data stored in data to be demodulated which data is input to the data demodulation processing unit 407, the data of the frame is input to the additional data decoding unit 408 via the switch 410. Whether the additional information bit is [0] or [1] can be determined by only calculating the total parity of the data area in the additional data decoding unit 408.

The additional data decoding unit 408 performs similar processing on the modulated data of areas necessary to decode intermittently input additional data. The additional data decoding unit 408 thereby obtains the additional data such for example as key data as n-bit information, key generating information, content reproduction control information, content copy control information, or other content attribute information. Incidentally, this additional data includes an error correcting code as mentioned in the description of the data recording processing device. The additional data is subjected to error correction in the additional data error correcting unit 409, and then output.

Incidentally, when the additional data is key information applied to the decryption of contents, for example, the additional data is output to a decryption processing unit that decrypts the contents. When the additional data is content reproduction control information, the additional data is output to a reproduction controlling unit.

As for general data other than the additional data, the data read from the information recording medium is output from the synchronism detecting unit 406 to the data demodulation processing unit 407. Data conversions reverse to those described above with reference to FIGS. 2A to 3H are sequentially performed, whereby reproduced data is obtained.

As with the additional data, main data as demodulated data includes an error correcting code. The main data is subjected to error correction in the main data error correcting unit 412, and then output.

Incidentally, when the output data is encrypted contents, for example, the output data is subjected to a decrypting process applying an encryption key that can be generated on the basis of key generating information output as the additional data, and then output via outputting means such as a display, a speaker and the like.

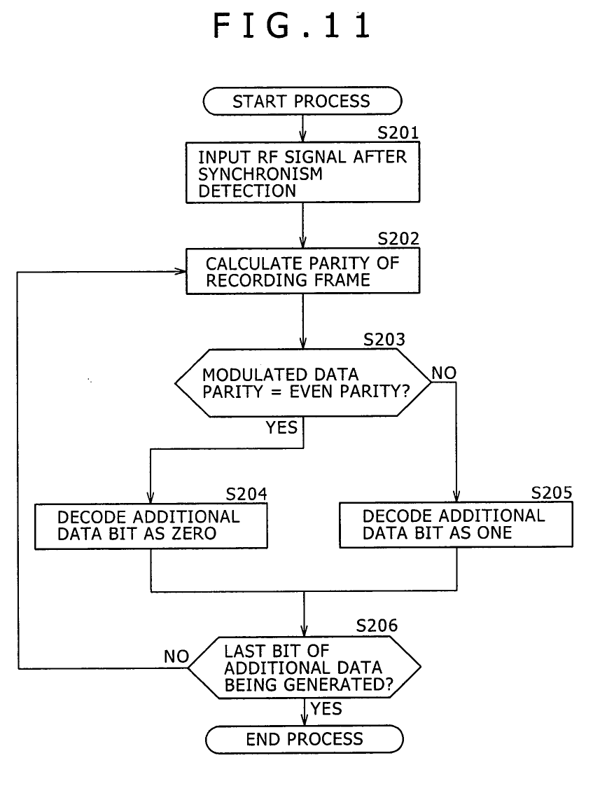

A reproduction process sequence including additional information reading will next be described with reference to FIG. 11. The process of FIG. 11 is performed in the reproduction processing device shown in FIG. 10.

In step S201, an RF signal is generated on the basis of a signal read from the information recording medium. In step S202, demodulation processing is performed on the RF signal, and the parity of a modulated recording frame corresponding to an additional data storing area is calculated. The total parity of the modulated recording frame shown in (c) of FIG. 6 and (c) of FIG. 7 is calculated.

In step S203, it is determined whether the total parity of the modulated recording frame is even parity. When the total parity of the modulated recording frame is even parity, it is determined in step S204 that an additional data bit=0. When the total parity of the modulated recording frame is odd parity, it is determined in step S205 that the additional data bit=1.

In step S206, it is determined whether the additional data bit is a last bit of additional data. When there is an unprocessed bit, the process from step S202 on down is repeated. When the last bit of the additional data is processed, the process is ended.

It is to be noted that while the foregoing embodiment has been described centering on an example using parity information, parity is an example of state information of a data area, and various other detectable state values are applicable. That is, various information other than parity is applicable as long as the information represents a state obtained from data.

In addition, in the above-described embodiment, additional data information is set by setting the parity of user control data (UCD) to even parity or odd parity, the present invention is not limited to user control data (UCD). When there is a bit-adjustable area in another data area, the data area may be set as additional data-corresponding data to be controlled at a time of writing and to be decoded at a time of data reading.

The present invention has been explained above in detail with reference to a specific embodiment thereof. It is obvious, however, that modifications and substitutions in the embodiment may be made by those skilled in the art without departing from the spirit of the present invention. That is, the present invention has been disclosed in a form that is illustrative and is thus not to be construed in a restrictive manner. In order to determine the spirit of the present invention, a section of claims described at the beginning hereof is to be considered.

Incidentally, the series of processes described in the specification can be carried out by hardware or by software or by a composite configuration of both. When the processes are to be carried out by software, a program in which process sequences are recorded can be installed into a memory within a computer incorporated in special hardware, and then executed, or installed onto a general-purpose computer capable of performing various processing, and then executed.

For example, the program can be recorded in advance on a hard disk or in a ROM (Read Only Memory) as a recording medium. Alternatively, the program can be stored (recorded) temporarily or permanently on a removable recording medium such as a flexible disk, a CD-ROM (Compact Disc Read Only Memory), an MO (Magneto Optical) disk, a DVD (Digital Versatile Disc), a magnetic disk, a semiconductor memory or the like. Such removable recording media can be provided as so-called packaged software.

In addition to being installed onto a computer from a removable recording medium as described above, the program can be transferred by radio from a download site to a computer or transferred to a computer by wire via a network such as a LAN (Local Area Network), the Internet or the like. The computer can receive the program thus transferred thereto, and install the program onto a recording medium such as a built-in hard disk or the like.

It is to be noted that the various processes described in the specification may be carried out not only in time series according to the description but also in parallel or individually according to processing capability of an apparatus performing the processes or as required. In the present specification, a system refers to a logical set configuration of a plurality of devices, and each constituent device is not necessarily present within an identical casing.

### INDUSTRIAL APPLICABILITY

As described above, according to a constitution of the present invention, when additional data is recorded onto an information recording medium, or additional information such for example as key information applied to a content decrypting process, key generating information, content reproduction control information, or copy control information is recorded onto the information recording medium, the value of a DC control bit embedded in a recording frame is determined and set according to the data state of an additional data recording area and constituent bit information [0] or [1] of the additional data. At a time of reproduction, the additional constituent bit information [0] or [1] can be obtained by detecting the data state of constituent data of the recording frame. Thus, the present invention is applicable to an information recording processing device, an information reproduction processing device, and an information recording medium when it is necessary, for example, to store contents whose copyright needs to be protected on a recording medium and embed additional information such as key information applied to a process of decrypting the contents, key generating information, content reproduction control information, copy control information or the like in a mode difficult to analyze.

According to a constitution of the present invention, in a process of recording additional data, for example, it is possible to record a constituent bit [0] or [1] of the additional data by only calculating the parity value of data of a recording frame in which to insert the additional data, and determining and setting the value of a DC control bit in the frame in which to store the additional data on the basis of information indicating whether the parity of the data of the recording frame is even parity or odd parity and the bit value information [0] or [1] of the additional data. At a time of reproduction, additional information can be obtained by only detecting the parity of read data. Thus, the present invention is applicable to an information recording processing device, an information reproduction processing device, and an information recording medium when it is necessary, for example, to store contents whose copyright needs to be protected on a recording medium and embed additional information such as key information applied to a process of decrypting the contents, key generating information, content reproduction control information, copy control information or the like in a mode difficult to analyze.

1. An information recording processing device comprising:
a modulated data generating unit for generating a modulated recording frame by setting a DC control bit in data to be recorded and performing data modulation processing; and
a DC control bit specifying unit for determining a bit value of the DC control bit set in a recording frame in which to store additional data on a basis of a constituent bit value of the additional data and a data state of constituent data of the recording frame.

2. The information recording processing device as claimed in claim 1,
wherein the data state of the constituent data of the recording frame in which to store said additional data is a state of whether parity of the constituent data of the recording frame is even parity or odd parity, and
said DC control bit specifying unit determines the bit value of the DC control bit set in the recording frame on a basis of two conditions of whether the constituent bit value of said additional data is zero or one and whether the parity of the constituent data of the recording frame is even parity or odd parity.

3. The information recording processing device as claimed in claim 1,
wherein said DC control bit specifying unit determines whether to set total parity of all DC control bits set in the recording frame in which to store said additional data to even parity or to odd parity on a basis of the constituent bit value of the additional data and the data state of the constituent data of the recording frame in which to store the additional data.

4. The information recording processing device as claimed in claim 1,
wherein said information recording processing device sets said additional data as constituent information of at least one of encryption key information, encryption key generating information, content reproduction control information, and content copy control information for contents stored on said information recording medium.

5. The information recording processing device as claimed in claim 1,
wherein said modulated data generating unit generates the modulated recording frame by performing a data conversion process satisfying RLL (1, 7) as a run length rule.

6. The information recording processing device as claimed in claim 1,
wherein said modulated data generating unit performs a modulated recording frame generating process including a process of conversion of two-bit information into three-bit information.

7. An information reproduction processing device for reproducing information stored on an information recording medium, said information reproduction processing device comprising:
a demodulating unit for demodulating data read from the information recording medium; and
an additional data decoding unit for calculating a state of recorded data, and obtaining constituent bit information of additional data as recorded information stored in an additional data recording area on a basis of a result of calculating the state.

8. The information reproduction processing device as claimed in claim 7,
wherein the state of the recorded data, said state being calculated by said additional data decoding unit, is parity of constituent data of a modulated recording frame corresponding to the additional data recording area, and whether a constituent bit value of said additional data is zero or one is determined on a basis of the state of whether the parity is even parity or odd parity.

9. The information reproduction processing device as claimed in claim 7,
wherein at least one of encryption key information, encryption key generating information, content reproduction control information, and content copy control information for contents stored on said information recording medium is generated on a basis of the obtained constituent bit information of the additional data.

10. An information recording medium wherein a recording frame corresponding to an additional data recording area is a recording frame in which a DC control bit having a bit value determined on a basis of two conditions of a constituent bit value of additional data and whether parity of constituent data of the recording frame is even parity or odd parity is set, and data based on the recording frame is recorded on the information recording medium.

11. The information recording medium as claimed in claim 10,
wherein the recording frame corresponding to said additional data recording area is recorded with total parity of DC control bits set to one of even parity and odd parity according to a predetermined rule on a basis of a correspondence between the constituent bit value of the additional data and a data state of the constituent data of the recording frame in which to store the additional data.

12. The information recording medium as claimed in claim 10,
wherein said additional data is stored as constituent information of at least one of encryption key information, encryption key generating information, content reproduction control information, and content copy control information for contents stored on said information recording medium.

13. The information recording medium as claimed in claim 10,
wherein the data based on a modulated recording frame generated by performing a data conversion process satisfying RLL (1, 7) as a run length rule is recorded.

14. The information recording medium as claimed in claim 10,
wherein the data based on a modulated recording frame generated by performing a process of converting two-bit information into three-bit information is recorded.

15. An information recording processing method comprising:
a DC control bit specifying step of determining a bit value of a DC control bit set in a recording frame in which to store additional data on a basis of a constituent bit value of the additional data and a data state of constituent data of the recording frame; and
a modulated data generating step of generating a modulated recording frame by setting the DC control bit specified in said DC control bit specifying step in data to be recorded and performing data modulation processing.

16. The information recording processing method as claimed in claim 15,
wherein the data state of the constituent data of the recording frame in which to store said additional data is a state of whether parity of the constituent data of the recording frame is even parity or odd parity, and
said DC control bit specifying step includes a step of determining the bit value of the DC control bit set in the recording frame on a basis of two conditions of whether the constituent bit value of said additional data is zero or one and whether the parity of the constituent data of the recording frame is even parity or odd parity.

17. The information recording processing method as claimed in claim 15,
wherein said DC control bit specifying step includes a step of determining whether to set total parity of all DC control bits set in the recording frame in which to store said additional data to even parity or to odd parity on a basis of the constituent bit value of the additional data and the data state of the constituent data of the recording frame in which to store the additional data.

18. The information recording processing method as claimed in claim 15,
wherein said additional data is constituent information of at least one of encryption key information, encryption key generating information, content reproduction control information, and content copy control information for contents stored on said information recording medium.

19. The information recording processing method as claimed in claim 15,
wherein said modulated data generating step generates the modulated recording frame by performing a data conversion process satisfying RLL (1, 7) as a run length rule.

20. The information recording processing method as claimed in claim 15,
wherein said modulated data generating step performs a modulated recording frame generating process including a process of conversion of two-bit information into three-bit information.

21. An information reproduction processing method for reproducing information stored on an information recording medium, said information reproduction processing method comprising:
a demodulating step of demodulating data read from the information recording medium; and
an additional data decoding step of calculating a state of recorded data, and obtaining constituent bit information of additional data as recorded information stored in an additional data recording area on a basis of a result of calculating the state.

22. The information reproduction processing method as claimed in claim 21,
wherein said additional data decoding step includes a step of calculating parity of constituent data of a modulated recording frame corresponding to the additional data recording area as the state of said recorded data, and determining whether a constituent bit value of said additional data is zero or one on a basis of the state of whether the parity is even parity or odd parity.

23. The information reproduction processing method as claimed in claim 21,
wherein said information reproduction processing method further includes a step of generating at least one of encryption key information, encryption key generating information, content reproduction control information, and content copy control information for contents stored on said information recording medium on a basis of the obtained constituent bit information of the additional data.

24. A computer program for performing an information recording process, said computer program comprising:
a DC control bit specifying step of determining a bit value of a DC control bit set in a recording frame in which to store additional data on a basis of a constituent bit value of the additional data and a data state of constituent data of the recording frame; and
a modulated data generating step of generating a modulated recording frame by setting the DC control bit specified in said DC control bit specifying step in data to be recorded and performing data modulation processing.

25. A computer program for reproducing information stored on an information recording medium, said computer program comprising:
a demodulating step of demodulating data read from the information recording medium; and
an additional data decoding step of calculating a state of recorded data, and obtaining constituent bit information of additional data as recorded information stored in an additional data recording area on a basis of a result of calculating the state.
